(19) United States
(12) Patent Application Publication
(10) Pub. No.: US 2012/0164486 A1
(43) Pub. Date: Jun. 28, 2012

(54) NICR AS A SEED STACK FOR FILM GROWTH OF A GAP LAYER SEPARATING A MAGNETIC MAIN POLE OR SHIELD

(76) Inventors: Christian René Bonhôte, San Jose, CA (US); Stefan Maat, San Jose, CA (US); Ning Shi, San Jose, CA (US); Brian R. York, San Jose, CA (US)

(21) Appl. No.: 12/975,547

(22) Filed: Dec. 22, 2010

(51) Int. Cl. G11B 5/33; G11B 5/265; G11B 5/10

(52) U.S. Cl. 428/812; 29/603.07; 428/816; 428/815.2

(57) ABSTRACT

A method and apparatus for a high-moment magnetic material used in a write head deposited on a gap layer that was grown using a nickel-chromium seed layer. The nickel-chromium seed layer provides the correct crystallographic orientation for both the nonmagnetic gap layer and the high-moment magnetic material such that the high-moment magnetic material has soft-magnetic properties and is useful as either a main pole or as shield layer in a write head. Moreover, the nickel-chronium seed layer, which may be exposed on the air bearing surface (ABS) of the write head, has an etch rate similar to other metals found in the ABS, thereby avoiding pole tip protrusion during later processing.

### BACKGROUND OF THE INVENTION

1. Field of the Invention

Embodiments of the present invention generally relate to fabricating a high-moment magnetic material for writing data to a magnetic disk, and more particularly to a method for manufacturing the high-moment magnetic material grown from a gap layer with a corresponding seed layer.

2. Description of the Related Art

The heart of a computer's long term memory is an assembly that is referred to as a magnetic disk drive. The magnetic disk drive includes a rotating magnetic disk, write and read heads that are suspended by a suspension arm adjacent to a surface of the rotating magnetic disk, and an actuator that swings the suspension arm to place the read and write heads over selected circular tracks on the rotating disk. The read and write heads are directly located on a slider that has an air bearing surface (ABS). The suspension arm biases the slider toward the surface of the disk, and when the disk rotates, air adjacent to the disk moves along with the surface of the disk. The slider flies over the surface of the disk on a cushion of this moving air. When the slider rides on the air bearing, the write and read heads are employed for writing magnetic transitions to and reading magnetic transitions from the rotating disk. The read and write heads are connected to processing circuitry that operates according to a computer program to implement the writing and reading functions.

The write head has traditionally included a coil layer embedded in first, second and third insulation layers (insulation stack), the insulation stack being sandwiched between first and second pole piece layers. A gap is formed between the first and second pole piece layers by a gap layer at an ABS of the write head and the pole piece layers are connected at a back gap. Current conducted to the coil layer induces a magnetic flux in the pole pieces which causes a magnetic field to fringe out at a write gap at the ABS for the purpose of writing the aforementioned magnetic transitions in tracks on the moving media, such as in circular tracks on the aforementioned rotating disk.

In general, a write head may consist of a high-moment magnetic core, a shield, and a gap layer located in between the core and shield. Suitable gap layer materials include rhodium (Rh), ruthenium (Ru), iridium (Ir), and platinum (Pt), and/or other platinum metals which are corrosion resistant and have atomic numbers that vary from those of transition metals (e.g., Co and Fe). However, these materials by themselves often have poor adhesion due to chemical inertness. Accordingly, a seed layer may first be deposited to improve adhesion of the primary gap material; however, the selection of an appropriate seed material affects not only the deposited gap layer, but also the downstream fabrication steps. Specifically, grain size and the crystallographic orientation of the seed material may determine the softness of a high-moment core (e.g., CoFe). In general, the seed material is a nonmagnetic metallic material with a small grain size and a crystallographic orientation that facilitates the right growth of the high-moment magnetic material that can achieve low in-plane coercivity and reminance. Once the write head is formed, the seed and gap material should also possess a similar ion etch rate relative to the other materials exposed on the ABS so that backend slider ABS formation will not result in pole tip protrusion (PTR). If materials forming the ABS have different etch rates, the resulting PTR hinders low-flight height and signal spatial resolution during operation.

### SUMMARY OF THE INVENTION

Embodiments of the present invention generally relate to fabricating a high-moment magnetic material for writing data to a magnetic disk, and more particularly to a method for manufacturing the high-moment magnetic material grown from a gap layer with a corresponding seed layer.

One embodiment of the invention provides a method for fabricating a magnetic write head. The method generally comprises depositing a seed layer comprising nickel-chromium over a substrate followed by depositing a non-magnetic material contacting the seed layer and a magnetic material contacting the nonmagnetic material, wherein an air bearing surface of the write head comprises the seed layer, the nonmagnetic material, and the magnetic material.

In another embodiment, a magnetic write head is disclosed. The write head includes a shield layer. The write head includes a seed layer over the shield layer comprising nickel-chromium and a non-magnetic gap layer contacting the seed layer. The write head also includes a magnetic main pole contacting the gap layer.

In another embodiment, a magnetic write head is disclosed. The write head includes a first gap layer. The write head also includes a magnetic main pole contacting the first gap layer and a seed layer over the main pole comprising nickel-chromium. A non-magnetic second gap layer contacts the seed layer with a magnetic shield layer contacting the second gap layer.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic illustration of a disk drive system in which the invention might be embodied.

FIG. 2 is an ABS view of a slider, taken from line 2-2 of FIG. 1, illustrating the location of a magnetic head thereon.

FIG. 3 is a chart illustrating the etch rate of different materials according to the etch angle.

FIG. 4 is a chart illustrating the coercivity of CoFeNi grown on stacks consisting of different gap and seed layer materials, according to embodiments of the invention.

FIGS. 5A-5H are diagrams illustrating a method of manufacturing a high-moment magnetic material from a gap layer with a seed layer, according to embodiments of the invention.

FIGS. 6A-6E are diagrams illustrating a method of manufacturing a high-moment magnetic material from a gap layer with a seed layer, according to embodiments of the invention.

FIGS. 7A-7B are diagrams illustrating a magnetic write head, according to embodiments of the invention.

### DETAILED DESCRIPTION

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Embodiments of the invention are generally related to magnetic write heads, and more specifically to methods for fabrication of magnetic poles or shields from a gap layer with a corresponding nickel-chromium seed layer. These three elements of a write head may then be exposed on an ABS.

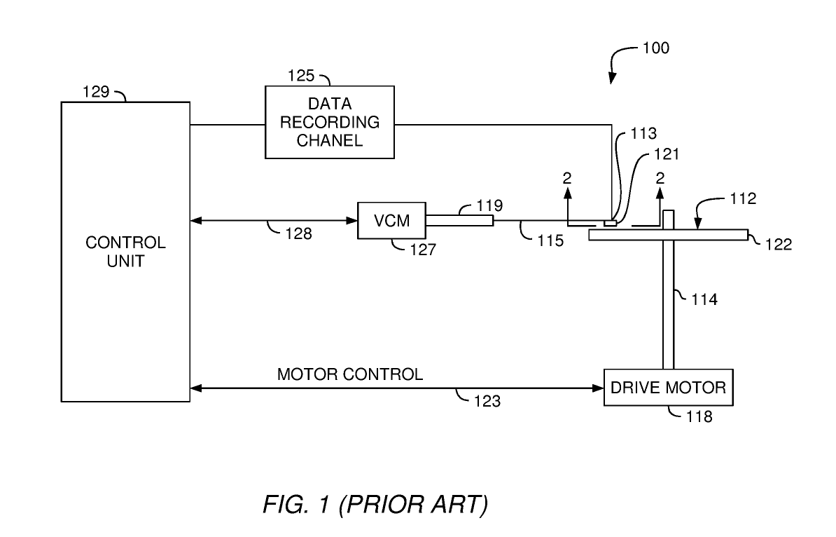

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, the slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by control unit 129.

During operation of the disk storage system, the rotation of the magnetic disk 112 generates an air bearing between the slider 113 and the disk surface 122 which exerts an upward force or lift on the slider 113. The air bearing thus counter-balances the slight spring force of suspension 115 and supports slider 113 off and slightly above the disk 112 surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

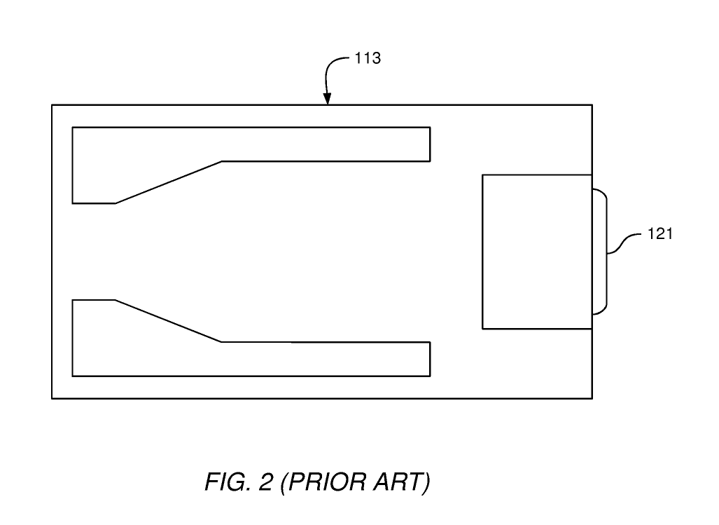

With reference to FIG. 2, the orientation of the magnetic head 121 in a slider 113 can be seen in more detail. FIG. 2 is an ABS view of the slider 113, and as can be seen, the magnetic head including an inductive write head and a read sensor, is located at a trailing edge of the slider 113. The above description of a typical magnetic disk storage system and the accompanying illustration of FIG. 1 are for representation purposes only. It should be apparent that disk storage systems may contain a large number of disks and actuators, and each actuator may support a number of sliders.

The present embodiments of the invention focus on the fabrication of a write head consisting of a shield layer, gap layer with a corresponding seed layer, and high-moment magnetic core. In general, the seed layer is first deposited which permits a gap material to be grown with a corresponding crystal orientation. Accordingly, when a magnetic material is deposited onto the gap material, the magnetic material also adopts the crystal orientation to result in a high-moment magnetic material.

Suitable gap layer materials include Rh, Ru, Ir, Pt or other Pt group metals which are corrosion resistant and have atomic numbers that vary from those of transition metals (e.g., Cobalt and Iron). However, these materials by themselves often have poor adhesion due to chemical inertness. Accordingly, a seed layer may first be deposited to improve adhesion of the primary gap material; however, the selection of an appropriate seed material affects not only the deposited magnetic materials, but also the downstream fabrication steps. Specifically, the grain size and crystallographic orientation of the seed material determines the softness of a high-moment core (e.g., CoFe). In general, the seed material is a nonmagnetic metallic material with a crystallographical orientation that facilitates the right growth of the high-moment magnetic material that can achieve low coercivity and reminance. Once the write head is formed, the seed material should also possess a similar ion etch rate so that backend slider ABS formation will not result in pole tip protrusion (PTR). If materials forming the ABS have different etch rates, the resulting PTR hinders low-flight height and signal special resolution during operation.

Previously, Ru has been used as a gap layer with a thin adhesion layer (i.e., the seed layer) of Chromium (Cr) or Tantalum (Ta). In one example, Ru with a thin layer of Cr or Ta was grown on top of a CoFe main pole and capped with a thicker Ru layer. Another layer of CoFe (acting as a shield layer) was grown on top of the Ru cap. In another example, the electro-plated main pole (e.g., CoFe) was grown directly from Ru that was deposited with a Ta or Cr seed layer. Using Cr or Ta as the seed layer, however, results in serious drawbacks.

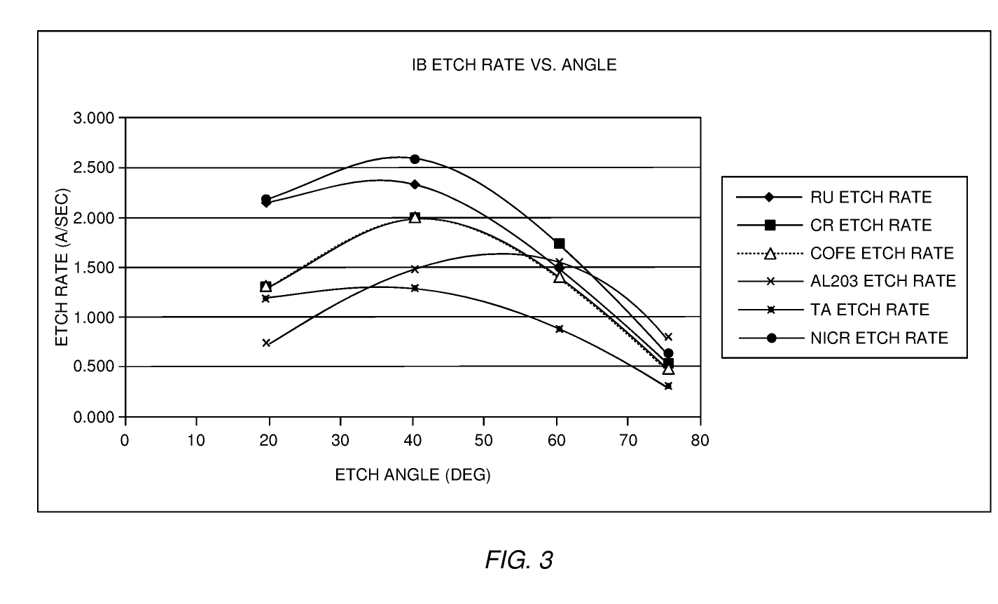

The atomic number of Ta provides a large critical dimension—scanning electron microscopy (CDSEM) contrast with the CoFe main pole—i.e., facilitates the growth of a high-moment main pole. However, the Ta seed layer negatively affects later manufacturing of the write head. As shown in FIG. 3, Ta etches at a slower etch rate than the other metals exposed at the ABS. For example, at a 60 degree etching angle, Ta has the lowest etch rate. Accordingly, the aerodynamics of the ABS suffers because the Ta seed layer protrudes during backend ABS formation—i.e., the other exposed metals etch quicker. Ideally, the materials found in the ABS should all etch at a similar rate.

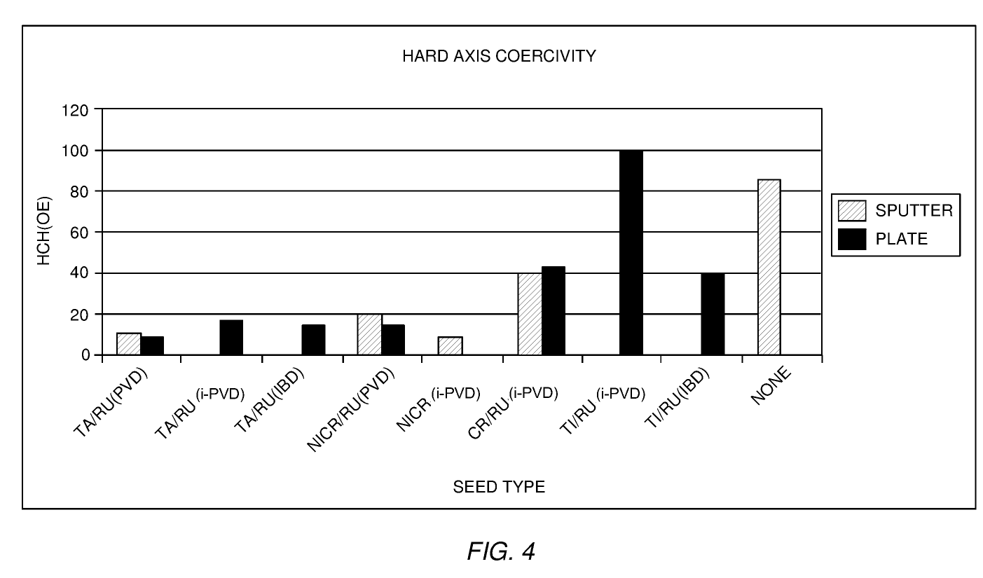

Using Cr, on the other hand, provides minimal PTR but has low CDSEM contrast with CoFe (i.e., does not provide the correct crystallographical orientation and microstructure to facilitate the growth of a high-moment main pole with the desired magnetic properties). As shown in FIG. 3, Cr does have a similar etch rate to metals exposed on the ABS at ion beam etching angles between 55-75 degrees thereby preventing PTR. However, FIG. 4 illustrates that a stack (a seed layer plus gap layer) consisting of Cr/Ru provides a main pole (e.g., CoFeNi with Ni being the minority dopant) with hard coercivity. Accordingly, the magnetic material deposited on top of the Cr/Ru stack lacks the desired soft-magnetic properties. A better, alternative stack should be compatible with the growth of the chosen high-moment core material, maintain good contrast, and have a similar etch rate of other materials found in the ABS so that PTR is minimized.

A stack of Nickel Chromium and Ruthenium (NiCr/Ru) satisfies these requirements. As shown in FIG. 3, NiCr etches at a similar rate to the other materials found in the ABS at etching angles around 55-75 degrees, thereby avoiding PTR. As shown in FIG. 4, the NiCr/Ru stack grows CoFeNi with soft magnetic properties, making it suitable for a high-moment main pole or shield. Moreover, a thin layer of aluminum oxide (e.g., alumina) may be deposited to increase the CDSEM contrast between NiCr and a CoFe alloy.

The process of creating a NiCr/Ru stack that grows a high-moment magnetic material is discussed in the following two embodiments: Damascene Main Pole Formation by electrochemical plating and the main pole formation by subtractive process from thin film on a flat substrate surface, i.e., mask and mill. The main pole formation by subtractive process may be referred to as the Dry-Pole Process in contrast to the wet plating Damascene main pole formation process.

### Damascene Main Pole Formation

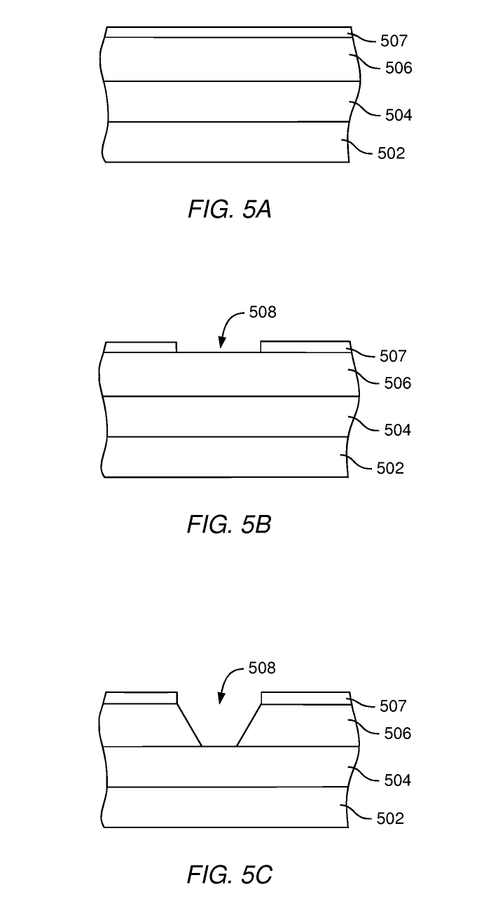

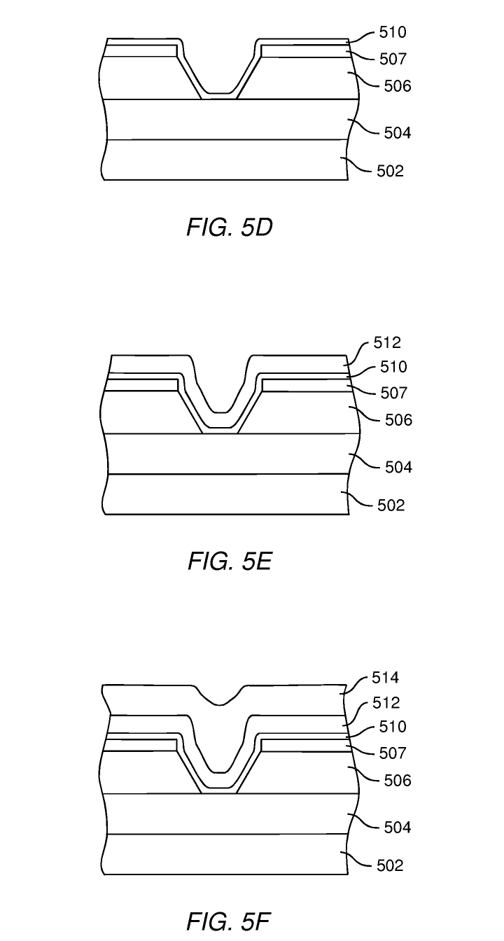

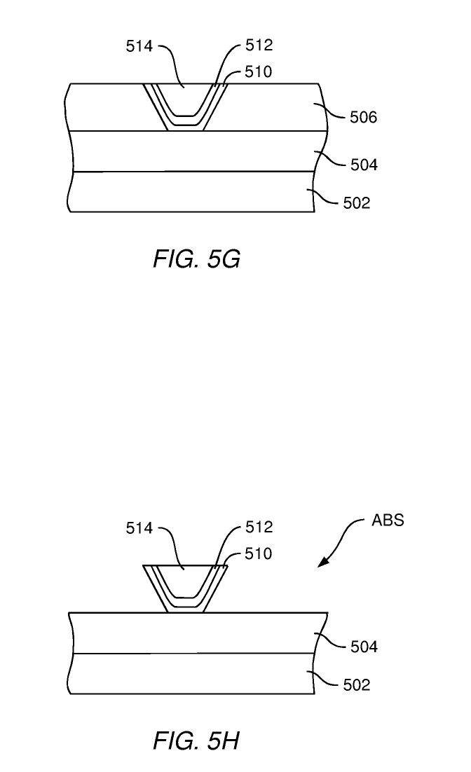

FIGS. 5A-5H illustrate a Damascene main pole formation using a seed layer to form the gap layer according to embodiments of the invention. As shown in FIG. 5A, a first reactive ion etching (RIE) stop layer 504 is deposited on a substrate 502 using a common vacuum deposition process or an electrodeposition process, such as electroplating or electroless deposition. The substrate 502 is not limited to a single layer or composition, and as used herein, the “substrate” is a general term to refer to a starting layer of the disclosed process. In one embodiment, the substrate 502 consists of other layers and materials that would be used in the formation of a magnetic write head. For clarity, these additional layers and their associated processes are omitted. A sacrificial layer 506 is then deposited such that it is at least as thick as the desired thickness of the write pole and gap thickness, as will become apparent below. The sacrificial layer 506 may comprise of alumina (Al₂O₃), silicon dioxide (SiO₂), silicon nitride, or other reaction ion etchable (RIEable) material and be deposited and formed by using a variety of standard techniques. One of ordinary skill in the art will recognize that other removal techniques may be used to remove and modify the sacrificial layer A second RIE-stop layer 507 is then deposited on top of the sacrificial layer 506 using a vacuum deposition process or by electro-chemical plating process. In one embodiment, the first and second RIE-stop layers 504, 507 may comprise various materials that are inert when subjected to reactive ion etching. In another embodiment, the first and second RIE-layers 504, 507 may be a material that is functionally useful to the write head device such as a shield layer; for example, a magnetic material selected from the group consisting of nickel-iron alloy, cobalt-iron alloy, cobalt-nickel-iron alloy, and combinations thereof.

FIG. 5B illustrates a trench 508 which may be created using any common lithography lift-off method,. In one embodiment, the second RIE-stop layer 507 functions as a mask for expanding the trench 508 in processing steps discussed below.

As shown in FIG. 5C, the trench 508 now is recessed into the sacrificial layer 506 through the RIE mask (507) opening. In one embodiment, a RIE process is used to etch away the sacrificial layer 506. Advantageously, using a RIEable material as the sacrificial layer 506 permits the removal of the sacrificial layer without affecting the first RIE-stop layer 504 (e.g., NiFe). The RIE action process may be manipulated so that a trapezoidal shape is created in the sacrificial layer 506.

FIG. 5D illustrates the deposition of a conformal seed layer 510 using ion beam deposition (IBD), physical vapor deposition process (PVD), or Atomic Layer Deposition (ALD) with a deposition thickness that is preferably less than 20 nm. In general, the seed layer 510 should be non-magnetic and improve the adhesion of the gap material. Advantageously, NiCr fulfills these requirements as well as having an etch rate similar to other metals found in the ABS. Moreover, a NiCr/Ru stack enables the growth of a high-moment magnetic material. For example, using a thin NiCr seed layer for a NiCr/Ru stack results in a CoFe main pole with small grain size and a 110 texture of body centric cubic structure.

In one embodiment, a thin layer of Ru may be deposited along with the NiCr to form the seed layer 510. Advantageously, after depositing the thin layer of NiCr, the layer of Ru (or other suitable metal from the Pt family) is deposited using PVD to facilitate the growth of the gap layer which is discussed next. Typically, the combined thin layers of NiCr and Ru may be less than 20 nm—e.g., less than 10 nm of NiCr and 10 nm of Ru.

Although FIG. 5D illustrates the seed layer 510 as a separate layer, the seed layer 510 may be thin enough (e.g., a couple to tens of nanometers) to be considered part of the gap layer 512 which is typically around a hundred nanometers.

In FIG. 5E, a conformal gap layer 512 is deposited on top of the seed layer 510 using ALD, PVD, or sputtering. In one embodiment, when depositing a thin layer of Ru in the seed layer 510 using PVD in the embodiment discussed above, a gap layer 512 of Ru may be advantageously grown using ALD. Nonetheless, the gap layer 512 material may be chosen from Rh, Ru, Ir, and Pt which are corrosion resistant and have atomic numbers that vary from those of transition metals (e.g., cobalt and iron). Preferably, Ru is used because of its large CDSEM contrast with CoFe and its similar relative etch rate with other ABS materials. However, one of ordinary skill will recognize that a variety of materials may provide a similar contrast and etch rate; thus, this invention is not limited to the Pt family of elements.

In another embodiment, the gap layer 512 may coat the sides and bottom of the trench 508 equally, which ensures that the later deposited core material (or main pole) is equidistant from the shield layer. Moreover, the deposition of the gap layer 512 determines the size of the resulting main pole. Stated differently, the gap layer 512 deposition ensures that a plurality of main poles created on a substrate 502 have the same dimensions from one deposition run to another.

FIG. 5F illustrates the deposition of a high-moment main pole 514 using either electro-chemical plating or vacuum deposition. In either process, the main pole 514 material adopts the orientation of the seed and gap layer 510, 512 which ensures that the main pole 514 material has soft-magnetic properties. The main pole material may be a cobalt-iron or an alloy thereof, such as CoFeNi. As shown in FIG. 4, a NiCr/Ru stack facilitates the growth of CoFeNi with low coercivity (i.e., soft-magnetic properties). This is due, in part, to the small grain size and optimized orientation of the NiCr seed layer 510 and the large CDSEM contrast between Ru and CoFe alloys.

FIG. 5G illustrates the removal of the excess high-moment main pole 514, gap layer 512, seed layer 510, and the second RIE-stop layer 507 from structure shown in FIG. 5F. Specifically, a combination of chemical-mechanical polishing (CMP) and ion beam milling may be used to remove the materials above the sacrificial layer 506.

FIG. 5H illustrates the removal of the sacrificial layer 506. Specifically, any etching technique that selectively removes the sacrificial layer 506 (e.g., alumina) may be used. The remaining main pole 514, gap layer 512, and seed layer 510, along with the trapezoidal structure, provide a low coercivity high-moment magnetic main pole 514 for a magnetic write head. Several other processing step may be followed (not shown) to create a magnetic write head from the process discussed above. Additionally, the plane in view is a plane typical of an ABS. Thus, a part of the write head structure depicted in FIG. 5H may be contained within the magnetic head assemblies 121 shown in FIG. 2. Accordingly, the magnetic head assemblies 121 may comprise of the materials that form the seed layer 510, gap layer 512, and main pole 514. The ABS may then be etched (not shown) to create the necessary aerodynamic features for the recording head device including the write head.

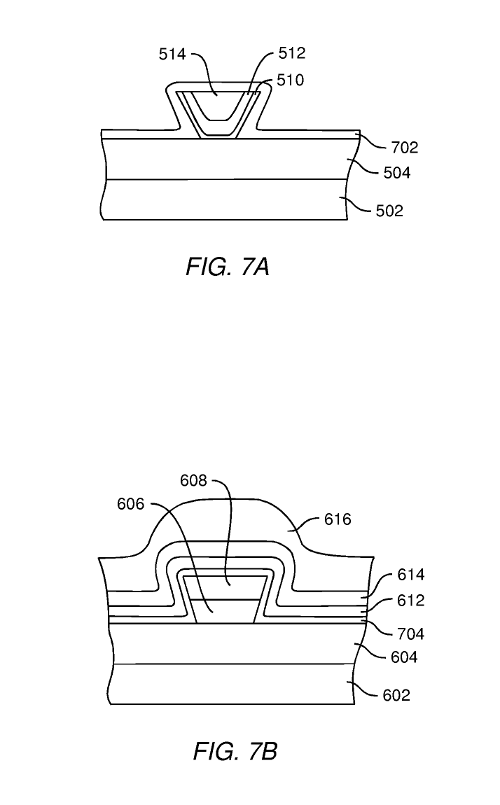

FIG. 7A illustrates a magnetic write head developed using a Damascene process shown in FIGS. 5A-H, according to embodiments of the invention. As shown, a contrast layer 702 is deposited around the write head comprising the main pole 514, gap layer 512, and seed layer 510. In one embodiment, the gap layer 512 may be thin enough relative to the NiCr seed layer 510 that the thickness of the NiCr seed layer 510 needs to be accounted for by the CDSEM metrology (i.e., the seed layer minimizes the CDSEM contrast because of the reduced thickness of the gap layer 512). In such a case, a contrast layer 702 may be deposited. The need for a contrast layer 702 arises because the atomic numbers of Ni, Cr, Co, and Fe are relatively similar. The main pole 514 or surrounding shield (not shown) may comprise of these materials and thus the contrast layer 702 may provide greater CDSEM contrast. In general, the contrast layer 702 may be any material that provides a high CDSEM contrast with the main pole 514. Specifically, implementing alumina as the contrast layer 702 provides such a contrast when using CoFe as the main pole 514. Using the stack materials discussed above, in one embodiment, the resultant stack is Al₂O₃/NiCr/Ru. Advantageously, as shown by FIGS. 3, alumina does not suffer the same etch rate problem as Ta (i.e., avoids PTR in the ABS) yet further increases the CDSEM contrast between a NiCr seed layer 510 and a surrounding shield or main pole 514. However, in embodiments where the gap layer 512 is substantially thicker than the seed layer 510 (e.g., greater than 100 nm) a contrast layer 702 may not be needed.

### Dry-Pole Process

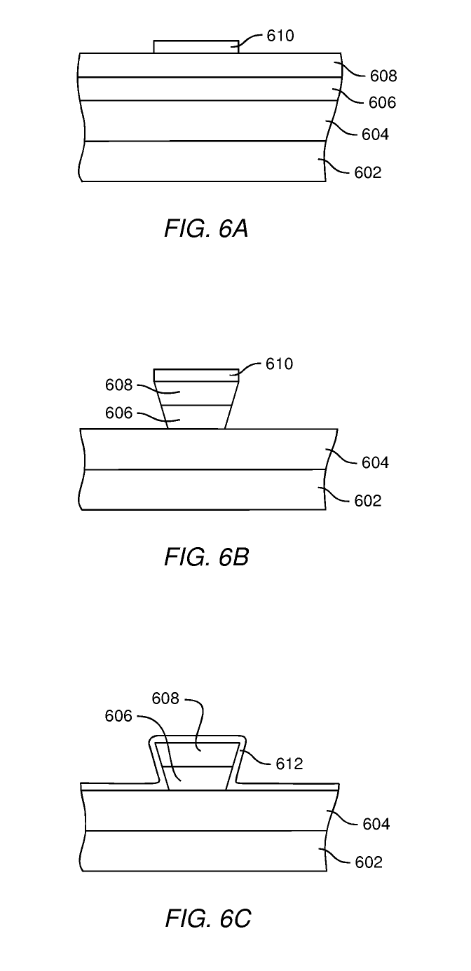

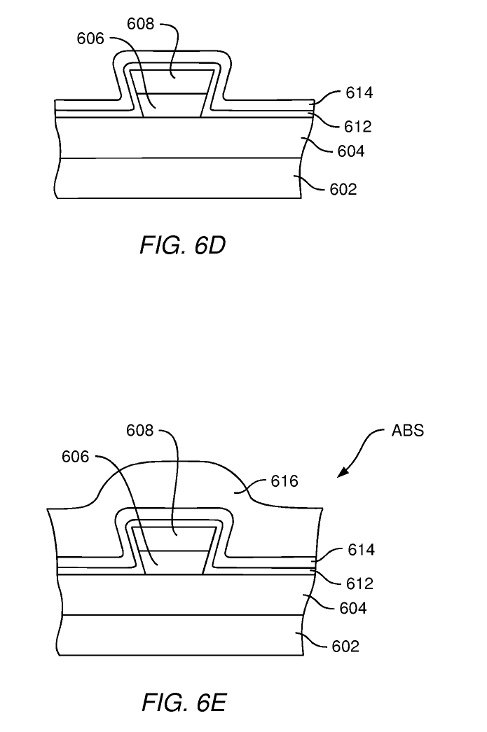

FIGS. 6A-6F illustrate a dry-pole process using a seed layer to form the gap layer according to embodiments of the invention. As shown in FIG. 6A, the substrate 602 includes a base layer 604 deposited on top of the substrate 602. In general, the substrate 602 is not limited to a single layer or composition, and as used herein, the “substrate” is a general term to refer to a starting layer of the disclosed process. In one embodiment, the substrate 602 consists of other layers and materials that would be used in a magnetic write head. For clarity, these additional layers and their associated processes are omitted.

In one embodiment, the base layer 604 provides a flat surface to deposit later materials. In another embodiment, the base layer 604 is a shield layer made up of a magnetic material, such as NiFe or a CoFe alloy, deposited by electro-chemical plating or electroless plating or vacuum deposition. A first gap layer 606 is then deposited on top of the base layer 604 consisting of a non-magnetic material such as Ta, Ru, Rh, Ir, or Pt. A high-moment or high moment lamination main pole 608 is then deposited on top of the first gap layer 606 by vacuum deposition. A mask 610 is placed on top of the main pole 608 using a typical lithography process known to those skilled in the art. As distinguished from the Damascene process, the dry-pole process may grow the main pole 608 from a flat surface rather than growing it from a metallic seed layer. Nonetheless, to effectively create a shield around the main pole 608, a nickel-chromium seed layer may be used. This process is described below.

FIG. 6B illustrates the results of ion beam milling which removes section of the main pole 608 and first gap layer 606 that were not covered by the mask 610. The trapezoidal shape may be formed by either sweeping/rotating the ion beam milling or rotating the substrate 602 itself. For example, the substrate 602 may be located on a tilted planetary that rotates during the milling operation in a manner to give the desired shape. The one or more angles may be from 10° to 60° relative to normal and may be angled outward from the bottom of the first gap layer 606 to the top of the main pole 608.

In one embodiment, the trapezoidal shaped structure, including the first gap layer 606 and main pole 608, may be physically supported by depositing a non-magnetic material—e.g., alumina—around the main pole 608. Although not shown, the support material provides the trapezoidal structure with stability during further processing steps.

FIG. 6C illustrates the deposition of a conformal seed layer 612 using IBD and/or PVD. In general, the seed layer 612 should be non-magnetic and improve the adhesion of the gap material (e.g., Ta, Cr, Ti, or NiCr). Advantageously, NiCr fulfills those requirements as well as having an etch rate similar to other materials found in the ABS. Moreover, a NiCr/Ru stack enables the growth of a high-moment magnetic material with desired magnetic properties. For example, using a thin NiCr seed layer for a NiCr/Ru stack results in a CoFe shield layer 616 with the desired microstructure. Preferably, the seed layer 612 may be less than 20 nm.

In one embodiment, a layer of Ru may be deposited along with the NiCr to form the seed layer 612. Advantageously, the layer of Ru is deposited using PVD after the thin layer of NiCr to facilitate the growth of the second gap layer which is discussed next. Typically, the combined thin layers of NiCr and Ru may be less than 20 nm—e.g., 10 nm of NiCr and 10 nm of Ru.

In FIG. 6D, a second gap layer 614 is deposited on top of the seed layer 612 using ALD, PVD, or sputtering. In one embodiment, when including a thin layer of PVD Ru in the seed layer 612 in the embodiment discussed above, a second gap layer 512 of Ru may be advantageously grown using an ALD process. The second gap layer 614 material may be chosen from Rh, Ru, Ir, and Pt which are corrosion resistant and have atomic numbers that vary from those of transition metals (e.g., cobalt and iron). Preferably, Ru is used because of its large CDSEM contrast with transition metals Co, Fe, Ni, etc. However, this invention is not limited to the Pt family of elements. Preferably, the second gap layer 612 is much larger than the seed layer 612 to improve CDSEM contrast (e.g., greater than 100 nm).

Although FIG. 6D illustrates the seed layer 612 as a separate layer, the layer is non-magnetic in nature and may be considered part of the second gap layer 614 which results in a second gap layer 614 that is typically hundreds of nanometers thick.

FIG. 6E illustrates the deposition of a high-moment shield layer 616 using either electro-chemical plating or vacuum deposition. In either process, the shield layer 616 material acquired desired microstructure seeding from seed layer 612 and second gap layer 614. This ensures that the shield layer 616 material has soft-magnetic properties to operate as a containing shield for the main pole 608. The shield layer 616 material may be a cobalt-iron or an alloy thereof, such as CoFeNi. As shown in FIG. 4, a NiCr/Ru stack facilitates the growth of CoFeNi with a low coercivity (i.e., soft-magnetic properties). This is due, in part, to the desired microstructure seeding from NiCr seed layer 612. The CDSEM contrast between Ru and CoFe alloys ensures precise CD measurement. In another embodiment, one portion of the shield layer 616 may be composed of CoFe (or an alloy thereof) grown from the seed layer 612 and second gap layer 614, while a second portion of the shield layer 616 may be composed of a different soft-magnetic alloy. In another embodiment, the base layer 604 is also composed of a high-moment material and may be used in combination with the shield layer 616 to encapsulate the main pole 608. This creates a wrap around shield (WAS). Also note that the first and second gap layer 606, 614 may create a uniform gap layer between the main pole 608 and the WAS (i.e., the combined base and shield layers 604, 616).

The low coercivity CoFe alloy provides a high-moment shield layer 616 suitable for a magnetic write head. Several other processing step may be followed (not shown) to create a magnetic write head from the process discussed above. Additionally, the plane in view of FIG. 6E is a plane typical of an ABS. Thus, a part of the write head structure depicted in FIG. 6E may be contained within the magnetic head assemblies 121 shown in FIG. 2. Accordingly, the magnetic head assemblies 121 may comprise of the materials that create the seed layer 612, main pole 608, and second gap layer 614. The ABS may then be etched (not shown) to create the necessary aerodynamic features for the recording head device including the write head.

FIG. 7B illustrates a magnetic write head developed using a dry-pole process, according to embodiments of the invention. As shown, before depositing the seed layer 612, a contrast layer 704 may be deposited similar to the contrast layer 702 discussed in FIG. 7A. Because the atomic numbers of Ni, Cr, Co, and Fe are relatively similar, the CDSEM contrast between a NiCr seed layer 612 and a CoFe shield layer 616 is slight. In many cases, the small CDSEM contrast between a NiCr seed layer 612 and a CoFe shield layer 616 is inconsequential because of the large CDSEM contrast between the gap layer 614 (e.g., Ru) and the CoFe shield layer 616. The effect of the low contrast between NiCr and CoFe is further minimized by depositing only a thin seed layer of NiCr (tens of nanometers) while depositing a much thicker layer of Ru (thousands of nanometers). However, the thickness of the seed layer may be increased, or the affect of the low CDSEM contrast may be minimized even further, if the contrast layer 704 is deposited as part of the stack. In the dry-pole process illustrated in FIG. 7B, this may occur before the seed layer 612 (e.g., NiCr, Ti, Cr, or Ta) is deposited (FIG. 6C). In general, the contrast layer 704 may be any material that provides a high CDSEM contrast with the main pole 514. Specifically, using alumina as the contrast layer 704 provides such a contrast when using CoFe as the shield layer 616. Using the stack materials discussed above, in one embodiment, the resultant stack is Al₂O₃/NiCr/Ru on which the high-moment CoFe (now used as a shield layer) is then deposited. Advantageously, as shown by FIG. 3, alumina does not suffer the same etch rate problem as Ta (i.e., avoids PTR in the ABS) yet further increases the CDSEM contrast.

While the foregoing is directed to embodiments of the present invention, other and further embodiments of the invention may be devised without departing from the basic scope thereof, and the scope thereof is determined by the claims that follow.

1. A method for creating a magnetic write head, comprising:
depositing a seed layer comprising nickel-chromium over a substrate;
depositing a non-magnetic material contacting the seed layer; and
depositing a magnetic material contacting the nonmagnetic material, wherein an air bearing surface of the write head comprises the seed layer, the nonmagnetic material, and the magnetic material.

2. The method of claim 1, wherein the magnetic material comprises a ferromagnetic alloy selected from the group consisting of nickel-iron, cobalt-nickel-iron, cobalt-iron and combinations thereof.

3. The method of claim 1, wherein the seed layer includes ruthenium and a thickness of the seed layer is less than 50 nanometers.

4. The method of claim 1, wherein the nonmagnetic material comprises at least one of the following: rhodium, ruthenium, iridium, and platinum.

5. The method of claim 4, wherein the nonmagnetic material is ruthenium.

6. The method of claim 1, further comprising depositing a high-contrast material with a high CDSEM contrast to the magnetic material such that at least one of (i) the high-contrast material is deposited between the seed layer and the substrate, wherein the high-contrast material contacts the seed layer and (ii) the high-contrast material contacts the magnetic material, the nonmagnetic material, and the seed layer.

7. The method of claim 6, wherein the high-contrast material is alumina.

8. The method of claim 1, further comprising:
depositing a first shield layer over the substrate;
depositing a sacrificial layer contacting the first shield layer;
depositing a second shield layer contacting the sacrificial layer; and
etching a recess through the second shield layer and sacrificial layer to expose the first shield layer, wherein the seed layer contacts the exposed first shield layer, and wherein at least a portion of the magnetic material is deposited within the recess.

9. The method of claim 1, further comprising:
depositing a shield layer over the substrate;
depositing a gap layer contacting the shield layer;
depositing a main pole contacting the gap layer; and
etching at least two recesses through the main pole and the gap layer, wherein the seed layer contacts both the shield layer and the main pole.

10. A magnetic write head, comprising:
a shield layer;
a seed layer over the shield layer comprising nickel-chromium;
a non-magnetic gap layer contacting the seed layer; and
a magnetic main pole contacting the gap layer;

11. The write head of claim 10, wherein the seed layer contacts the shield layer.

12. The write head of claim 10, wherein the magnetic main pole comprises a ferromagnetic alloy selected from the group consisting of nickel-iron, cobalt-iron, cobalt-nickel-iron, and combinations thereof.

13. The write head of claim 10, further comprising a contrast layer that contacts the seed layer, the gap layer, and the main pole, wherein the contrast layer is a material with a high CDSEM contrast to the main pole.

14. The write head of claim 13, wherein the contrast layer is alumina.

15. The write head of claim 10, wherein the non-magnetic gap layer comprises at least one of the following: rhodium, ruthenium, iridium, and platinum.

16. The write head of claim 10, wherein the seed layer includes ruthenium, and wherein a thickness of the seed layer is less than 50 nanometers.

17. A magnetic write head, comprising:
a first gap layer;
a magnetic main pole contacting the first gap layer;
a seed layer over the main pole comprising nickel-chromium;
a non-magnetic second gap layer contacting the seed layer; and
a magnetic shield layer contacting the second gap layer.

18. The magnetic head of claim 17, wherein the shield layer comprises a ferromagnetic alloy selected from the group consisting of nickel-iron, cobalt-iron, cobalt-nickel-iron, and combinations thereof.

19. The magnetic head of claim 17, further comprising a contrast layer that contacts the seed layer, and wherein the contrast layer is between the main pole and seed layer, and wherein the contrast layer is a material with a high CDSEM contrast to the shield layer.

20. The write head of claim 19, wherein the contrast layer is alumina.

21. The magnetic head of claim 17, wherein the seed layer includes ruthenium, and wherein a thickness of the seed layer is less than 50 nanometers.

22. The write head of claim 17, wherein the non-magnetic second gap layer comprises at least one of the following: rhodium, ruthenium, iridium, and platinum.
